(19) United States
(12) Patent Application Publication
(10) Pub. No.: US 2012/0140533 A1
(43) Pub. Date: Jun. 7, 2012

(54) SOLAR PHOTOVOLTAIC SYSTEM WITH CAPACITANCE-CONVERTIBNG FUNCTION

(76) Inventor: Sheng-Hua Li, Taoyuan County (TW)

(21) Appl. No.: 13/166,549

(22) Filed: Jun. 22, 2011

(30) Foreign Application Priority Data
Dec. 2, 2010 (TW) 099141890

(51) Int. Cl. H02M 5/45

(52) U.S. Cl. 363/37

(57) ABSTRACT

A solar photovoltaic system with a capacitance-converting function provides a DC power source through a solar cell, and the DC power source is converted into an AC power source, thus performing a grid-connected operation with a utility power. The solar photovoltaic system further includes a capacitance conversion apparatus, a DC-to-DC converter, a DC-to-AC converter, and a filter circuit. In addition, the capacitance conversion apparatus has an inductor, a first power switch component, a second power switch component, and a capacitor, which are electrically connected to each other. Instead of the conventional electrolytic capacitor, the capacitor conversion apparatus is used to provide energy-storing, energy-releasing, and filtering functions, thus increasing the operation life of the solar

### BACKGROUND OF THE INVENTION

1. Field of the Invention

The present invention relates to a solar photovoltaic system, and more particularly to a solar photovoltaic system with a capacitance-converting function.

2. Description of Prior Art

The research and development of alternative energy resources have become the major issue and key polity in many developed countries over the world since the two oil crises of the 1970s. In addition, the oil prices rise because the industrial development promotes the global economic growth and results in the rapid growth of the oil demand. Hence, environmental issues have received more attention recently, and more particularly to the effects of carbon dioxide on air pollution. In order to effectively reduce our dependence on oil as a source of energy, a variety of renewable resources, such as solar energy, wind energy, and so on, are researched and developed.

Because the solar energy has the pollution-free and public harm-free characteristics and is further inexhaustible in supply and always available for use, the solar energy has high potential applications and developments. Recently with the rapidly development of the high-efficiency solar cells, this topic has been gradually promoted by making policies in many developed countries, such as Europe countries, the United States, Japan, and so on.

The solar photovoltaic system provides a photovoltaic conversion to generate a DC power through the solar cell panels. Afterward, the DC power is converted into an AC power through a power conditioner to supply to loads or the converted AC power is grid-connected to an AC utility power through the utility grid bus. The solar photovoltaic system can be broadly divided into three categories: (1) stand-alone system, (2) grid-connection system, and (3) hybrid system.

The stand-alone system means that the solar photovoltaic system is completely operational without requiring external support and only directly supply to loads. Hence, the stand-alone system is generally built in remote areas or isolated islands. The grid-connection system means that the solar photovoltaic system is further connected to the power grid of the electric power company. Hence, the grid-connection system is suitable for where the utility power can reach. When the amount of electricity generation of the solar photovoltaic system is greater than that of load demands, the redundant power remains would be delivered to the utility grid bus. On the other hand, the utility power can provide the required power electricity to loads when the amount of electricity generation of the solar photovoltaic system is insufficient. Furthermore, in order to improve the power supply reliability and quality, the hybrid system is developed. The solar photovoltaic system, which is combined with standby batteries, is temporarily separated from the utility power to provide power electricity to loads when the utility power fails. The solar photovoltaic system is further grid-connected to the utility grid bus until the utility power is available.

Reference is made to FIG. 1 which is a schematic view of the prior art solar photovoltaic system. A grid-connected solar photovoltaic system is exemplified for further demonstration, namely, the solar photovoltaic system is grid-connected to an AC utility power 60A. The solar photovoltaic system includes a solar cell 10A, an input filtering capacitor 20A, a DC/DC converter 30A, a DC/AC converter 40A, and a filtering circuit 50A. The solar cell 10A provides a DC output voltage Vpv and a DC output current Ipv by converting light energy into electric energy. The input filtering capacitor 20A is electrically connected to the solar cell 10A to provide functions of energy-storing, energy-releasing, and filtering for rear-end circuits. In general, the input filtering capacitor 20A is an electrolytic capacitor. The aluminum electrode, which is covered by the aluminum oxide film, of the electrolytic capacitor is placed into the conductive electrolytic solution. However, the electrolytic solution of the electrolytic capacitor is the major cause of reducing life time thereof. In general, the average life time of the electrolytic capacitor is about five years. The life time of the electrolytic capacitor would shorten, however, if the electrolytic capacitor is used in extreme conditions.

The DC/DC converter 30A is electrically connected to the input filtering capacitor 20A. In this embodiment, the DC/DC converter 30A is a flyback converter. The DC/DC converter 30A includes an isolated transformer 302A, a power switching element 304A, a diode 306A, and a filtering capacitor 308A. The DC/DC converter 30A receives the filtered output voltage from the input filtering capacitor 20A as a primary-side input voltage Vpr of the isolated transformer 302A. In addition, a primary-side input current Ipr flows into the isolated transformer 302A. The generated energy is sent to the output terminal by switching the power switching element 304A, and the voltage level of the filtered DC power is boosted up through the turn ratio between the primary-side winding and the secondary-side winding of the isolated transformer 302A.

The DC/AC converter 40A is electrically connected to the DC/DC converter 30A. In this embodiment, the DC/AC converter 40A is a full-bridge DC/AC converter. The DC/AC converter 40A has four power switching elements, namely, a first power switching element 402A, a second power switching element 404A, a third power switching element 406A, and a fourth power switching element 408A. In particular, each of the four power switching elements 402˜408 has an anti-parallel diode, also called body diode (not labeled). The DC/AC converter 40 is composed of two sets of legs, and each of the legs has two the above-mentioned power switching elements. As shown in FIG. 1, the first power switching element 402A and the second power switching element 404A form a leg, and the third power switching element 406A and the fourth power switching element 408A form the other leg. The power switching elements 402A˜408A of the DC/AC converter 40A can be driven through a sinusoidal pulse-width-modulation (SPWM) technology or a square-wave switching technology, thus converting the boosted DC power into the amplitude-modulated and frequency-modulated sinusoidal AC power.

The filtering circuit 50A is electrically connected to the DC/AC converter 40A. The filtering circuit 50A is composed of a filtering inductor 502A and a filtering capacitor 504A to filter out high-frequency harmonic components of the AC power produced from the DC/AC converter 40A.

In particular, the conversion efficiency and use life are the most important factors to the energy conversion of the solar photovoltaic system. However, the electrolytic solution of the electrolytic capacitor limits the use life of the solar photovoltaic system, thus reducing generation reliability and increasing capital costs and generation costs of the solar photovoltaic system.

Accordingly, it is desirable to provide a solar photovoltaic system with a capacitance-converting function to replace the conventional electrolytic capacitor, thus increasing life time of the solar photovoltaic system.

### SUMMARY OF THE INVENTION

In order to solve the above-mentioned problems, a solar photovoltaic system with a capacitance-converting function is disclosed. The solar photovoltaic system provides a direct current (DC) power through a solar cell and converts the DC power into an alternating current (AC) power, which is grid-connected to an AC utility power. The solar photovoltaic system includes a capacitance conversion apparatus, a DC/DC converter, a DC/AC converter, and a filtering circuit.

The capacitance conversion apparatus is electrically connected to the solar cell and has an inductor, a first power switching element, a second power switching element, and a capacitor which are electrically connected to each other, thus filtering the DC power and providing an energy conversion of the DC power. The DC/DC converter is electrically connected to the capacitance conversion apparatus to boost up the voltage level of the filtered DC power. The DC/AC converter is electrically connected to the DC/DC converter to convert the boosted DC power into the AC power. The filtering circuit is electrically connected to the DC/AC converter to filter out high-frequency harmonic components of the AC power.

Therefore, the solar photovoltaic system with a capacitance-converting function is provided to replace the conventional electrolytic capacitor, thus increasing life time of the solar photovoltaic system.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic view of the prior art solar photovoltaic system;

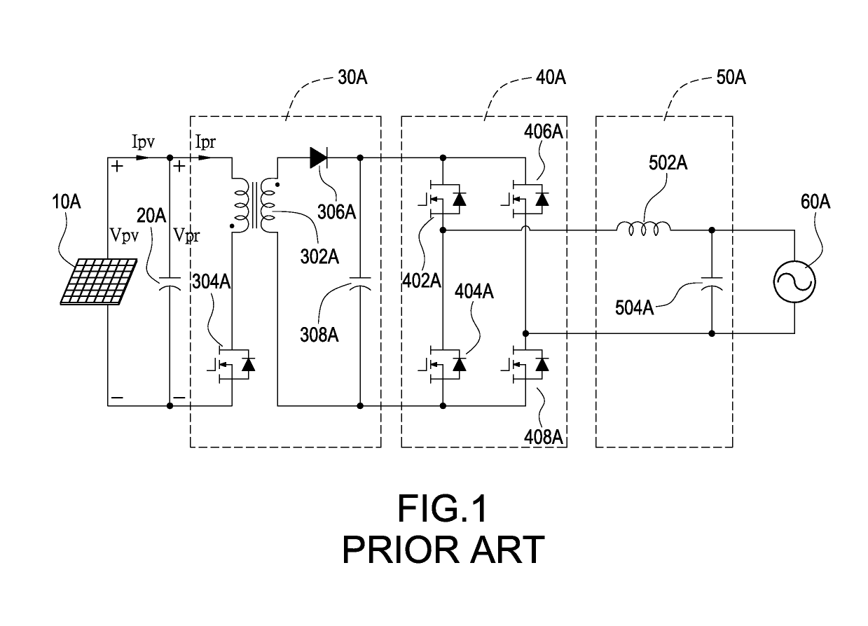

FIG. 2 is a circuit diagram of a solar photovoltaic system with a capacitance-converting function according to a preferred embodiment of the present invention; and

FIG. 3 is a circuit diagram of a capacitance conversion apparatus.

### DETAILED DESCRIPTION OF THE INVENTION

Reference will now be made to the drawing figures to describe the present invention in detail.

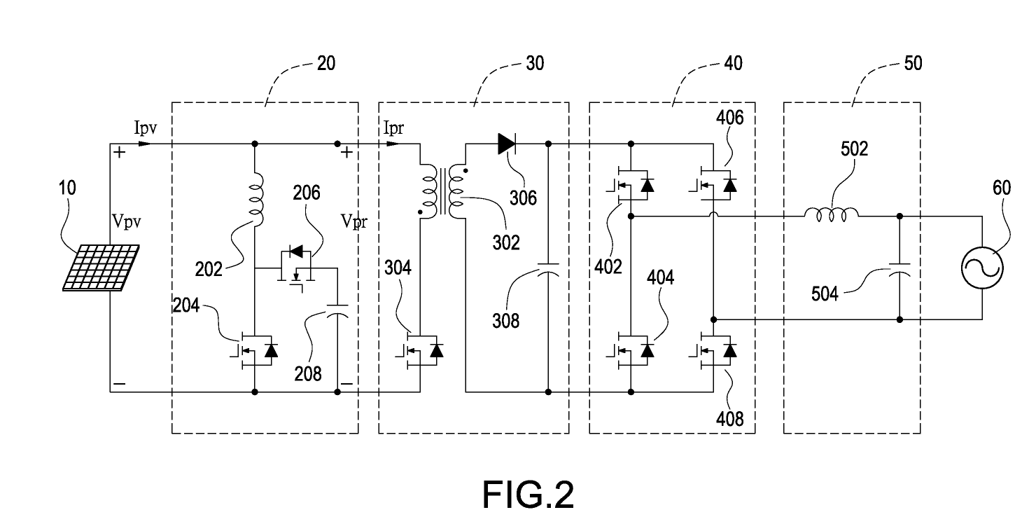

Reference is made to FIG. 2 which is a circuit diagram of a solar photovoltaic system with a capacitance-converting function according to a preferred embodiment of the present invention. The solar photovoltaic system with a capacitance-converting function provides a direct current (DC) power through a solar cell 10 and converts the DC power into an alternating current (AC) power, which is grid-connected to an AC utility power 60. In particular, the DC power has a DC output voltage Vpv and a DC output current Ipv. The solar photovoltaic system includes a capacitance conversion apparatus 20, a DC/DC converter 30, a DC/AC converter 40, and a filtering circuit 50.

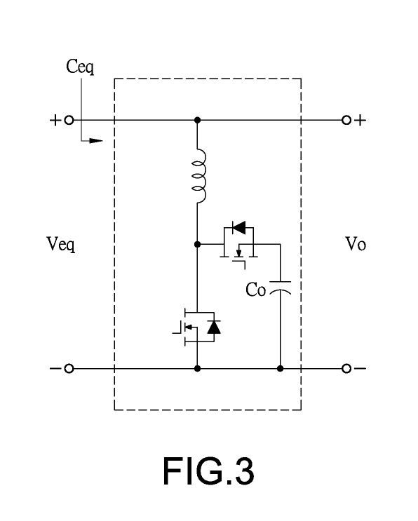

The capacitance conversion apparatus 20 is electrically connected to the solar cell 10 to filter the DC power and provide an energy conversion of the DC power outputted from the solar cell 10. Reference is made to FIG. 3 which is a circuit diagram of a capacitance conversion apparatus. The capacitance conversion apparatus 20 is a power electronics conversion apparatus. It is assumed that the capacitance conversion apparatus 20 is a lossless apparatus.

Hence, the energy stored in capacitance conversion apparatus 20 is the same during conversion process according the Energy Conservation Law. That is,

Ceq×Veq²=Co×Vo²;

wherein, Ceq and Veq are the equivalent input capacitance and the equivalent input voltage of the capacitance conversion apparatus 20, respectively; and Co and Vo are the equivalent output capacitance and the equivalent output voltage of the capacitance conversion apparatus 20, respectively. Hence, the equivalent input capacitance Ceq of the capacitance conversion apparatus 20, that is, Ceq=(Co×Vo²)/Veq². The low-voltage large-capacitance operation could be equivalent to the high-voltage small-capacitance operation through the capacitance conversion apparatus 20. Accordingly, the conventional low-voltage large-capacitance electrolytic capacitor could be replaced by the non-electrolytic capacitor, thus significantly increasing the use life of the solar photovoltaic system because of absence of the electrolytic capacitors.

As the above description, the capacitance conversion apparatus 20 has an inductor 202, a first power switching element 204, a second power switching element 206, and a capacitor 208. The capacitance conversion apparatus 20 is a boost converter to replace the conventional low-voltage large-capacitance electrolytic capacitor. The capacitance conversion apparatus 20 receives the DC output voltage Vpv and the DC output current Ipv from the solar cell 10. The capacitance conversion apparatus 20 provides functions of energy-storing, energy-releasing, and filtering according to the characteristics of the equivalent input capacitance thereof to the DC/DC converter 30.

The DC/DC converter 30 is electrically connected to the capacitance conversion apparatus 20 to boost up the voltage level of the filtered DC power. In this embodiment, the DC/DC converter 30 is a flyback converter. The DC/DC converter 30 has an isolated transformer 302, a power switching element 304, a diode 306, and a filtering capacitor 308. The DC/DC converter 30 receives an output voltage of the capacitance conversion apparatus 20 as a primary-side input voltage Vpr of the isolated transformer 302 thereof. In addition, a primary-side input current Ipr flows into the isolated transformer 302. When the power switching element 304 is turned on (closed), the electric energy is stored in the magnetizing inductance (not shown). In contrast, the electric energy is outputted when the power switching element 304 is turned off (opened). Because the output voltage of the solar cell 10 is lower, the voltage level of the filtered DC power is boosted up through the turn ration between the primary-side winding and the secondary-side winding of the isolated transformer 302, thus reducing the voltage variation of the output voltage due to the load variation. In addition, the DC/DC converter 30 provides a function of a maximum power point tracking (MPPT). That is, the optimal operation voltage and current can be found according to the introduced MPPT strategy by detecting the DC output voltage Vpv and DC output current Ipv of the solar cell 10, thus controlling the duty cycle of the adopted PWM signal and outputting the PWM signal to a driving circuit. Accordingly, the MPPT is realized to increase the output power of the solar cell 10 and generation efficiency of the solar photovoltaic system.

In particular, the inductor 202 provides different operations by controlling duty cycles of the first power switching element 204 and the second power switching element 206. That is, the inductor 202 provides energy-storing operation when the first power switching element 204 is turned on (closed) and the second power switching element 206 is turned off (opened). On the other hand, the inductor 202 provides energy-releasing operation when the first power switching element 204 is turned off (opened) and the second power switching element 206 is turned on (closed). Hence, the current which flows through the inductor 202 can compensate the harmonic energy of the primary-side input current Ipr flowing into the isolated transformer 302. Furthermore, the continuous inductor current of the capacitance conversion apparatus 20 significantly reduces high-frequency harmonic components of the AC power so that the number of the high-frequency filtering circuit can be reduced.

In addition, the second power switching element 206 of the capacitance conversion apparatus 20 can be replaced with a diode (not shown). The diode is turned on when the diode is applied through a forward-bias voltage; on the other hand, the diode is turned off when the diode is applied through a reverse-bias voltage. Accordingly, the diode can provide the turn-on and turn-off characteristics like switches to allow or block flowing current.

In addition, the DC/AC converter 40 is electrically connected to the DC/DC converter 30 to convert the boosted DC power into the AC power. In this embodiment, the DC/AC converter 40 is a full-bridge DC/AC converter. The DC/AC converter 40 has four power switching elements, namely, a third power switching element 402, a fourth power switching element 404, a fifth power switching element 406, and a sixth power switching element 408. In particular, each of the four power switching elements 402˜408 has an anti-parallel diode, also called body diode (not labeled). The DC/AC converter 40 is composed of two sets of legs, and each of the legs has two the above-mentioned power switching elements. As shown in FIG. 2, the third power switching element 402 and the fourth power switching element 404 form a leg, and the fifth power switching element 406 and the sixth power switching element 408 form the other leg. In addition, due to non-linearity in a solid-state switching element, such as turn-on delay and turn-off delay, the solid-state switching element does not immediately turn-on or turn-off when being driven by an input trigger command. In order to avoid both top and bottom side switching elements turning on or turning off simultaneously, a short delay time or so-called dead-time has to be added. The power switching elements 402˜408 of the DC/AC converter 40 are driven through a high-frequency switching technology. In particular, the high-frequency switching technology can be a sinusoidal pulse-width-modulation (SPWM) technology. That is, a PWM signal is generated by comparing a sinusoid wave (also called modulation wave) to a triangle wave (also called carrier wave) to control the power switching elements. In addition, the power switching elements 402˜408 of the DC/AC converter 40 are driven through a low-frequency switching technology. In particular, the low-frequency switching technology can be a square-wave switching technology. Accordingly, the DC/AC converter 40 converts the boosted DC power into the amplitude-modulated and frequency-modulated sinusoidal AC power.

In addition, the filtering circuit 50 is electrically connected to the DC/AC converter 40 to filter out high-frequency harmonic components of the AC power. In this embodiment, the filtering circuit 50 is composed of a filtering inductor 502 and a filtering capacitor 504. That is, the two-order low-pass filter including the filtering inductor 502 and the filtering capacitor 504 filter out high-frequency harmonic components of the AC power outputted from the DC/AC converter 40, thus producing a low-frequency sinusoidal signal with 60-Hz fundamental wave.

Therefore, the capacitance conversion apparatus 20 provides functions of energy-storing, energy-releasing, and filtering to replace the conventional electrolytic capacitor, thus increasing the operation life of the solar photovoltaic system.

In conclusion, the present invention has following advantages:

1. The conventional electrolytic capacitor is replaced by the capacitance conversion apparatus to solve the problem of reducing operation life of the electrolytic capacitor because of the electrolytic solution thereof, thus increasing the operation life of the solar photovoltaic system;

2. The capacitance conversion apparatus can be a power electronics conversion apparatus with the step-up function, thus providing flexibility of designing the capacitance conversion apparatus;

3. The continuous inductor current of the capacitance conversion apparatus significantly reduces high-frequency harmonic components of the AC power so that the number of the high-frequency filtering circuit can be reduced; and

4. The conventional electrolytic capacitor is replaced by the capacitance conversion apparatus to improve the reliability of power generation and reduce capital costs and generation costs of the solar photovoltaic system.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A solar photovoltaic system with a capacitance-converting function providing a direct current (DC) power through a solar cell and converting the DC power into an alternating current (AC) power, which grid-connected to an AC utility power; the solar photovoltaic system comprising:
a capacitance conversion apparatus electrically connected to the solar cell and having an inductor, a first power switching element, a second power switching element, and a capacitor which electrically connected to each other to filter the DC power and provide an energy conversion of the DC power;
a DC/DC converter electrically connected to the capacitance conversion apparatus to boost up a voltage level of the filtered DC power;
a DC/AC converter electrically connected to the DC/DC converter to convert the boosted DC power into the AC power; and
a filtering circuit electrically connected to the DC/AC converter to filter out high-frequency harmonic components of the AC power;
whereby the capacitance conversion apparatus provides functions of energy-storing, energy-releasing, and filtering to replace the conventional electrolytic capacitor, thus increasing the operation life of the solar photovoltaic system.

2. The solar photovoltaic system in claim 1, wherein the capacitance conversion apparatus is a boost converter.

3. The solar photovoltaic system in claim 1, wherein the DC/DC converter is a flyback converter.

4. The solar photovoltaic system in claim 1, wherein the DC/DC converter provides a function of a maximum power point tracking (MPPT).

5. The solar photovoltaic system in claim 1, wherein the DC/AC converter is a full-bridge DC/AC converter.

6. The solar photovoltaic system in claim 1, wherein the DC/AC converter has a plurality of power switching elements which are driven through a high-frequency switching technology.

7. The solar photovoltaic system in claim 1, wherein the DC/AC converter has a plurality of power switching elements which are driven through a low-frequency switching technology.

8. The solar photovoltaic system in claim 1, wherein the filtering circuit is composed of a filtering inductor and a filtering capacitor.

9. The solar photovoltaic system in claim 6, wherein the high-frequency switching technology is a sinusoidal pulse-width-modulation (SPWM) technology.

10. The solar photovoltaic system in claim 7, wherein the low-frequency switching technology is a square-wave switching technology.
